(19) United States
(12) Patent Application Publication
(10) Pub. No.: US 2007/0193610 A1
(43) Pub. Date: Aug. 23, 2007

(54) System For Semi-Automatic Line Cleaning

(75) Inventors: Werner Strothoff, Sassenberg-Fuchtorf (DE); Jorg Emmendorfer, Wuppertal (DE); Gerold Carlhoff, Tonisvorst (DE); Frank-Rainer Schuster, Erkrath (DE)

Correspondence Address: ECOLAB INC., MAIL STOP ESC-F7, 655 LONE OAK DRIVE, EAGAN, MN, 55121, US

(73) Assignee: Ecolab Inc., St. Paul, MN (US)

(21) Appl. No.: 10/599,392

(22) PCT Filed: Mar. 31, 2004
(86) PCT No.: PCT/EP04/03370

§ 371 Date: Sep. 27, 2006

(51) Int. Cl. B08B 3/00; B08B 9/00

(52) U.S. Cl. 134/166 R; 134/166 C; 134/56 R

(57) ABSTRACT

This invention describes a system for semi-automatic line cleaning in a beverage dispensing system, said beverage dispensing system comprising at least one tap (1) connected via at least one beverage line (3) to at least one coupling means (4) for a keg or other beverage container (5), said cleaning system comprising additional cleaning lines (8), a control unit (11) and at least one switching means (14) connected to the control unit (11) for switching between a tapping mode and a cleaning mode of the beverage dispensing system. It is preferred that the switching means (14) is designed as an electronic and/or a mechanical key switch so that the system is operable only by authorized personnel. Further it is preferred that the switching means (14) is additionally provided with an optical status indicator (17). Finally it is provided that, irrespective of the location of the control unit (11), the switching means (14) is positioned next to the beverage tap (1).

The invention relates to a system for semi-automatic line cleaning in a beverage dispensing system according to the preamble of claim 1.

A beverage dispensing system with tap and beverage line from a keg or other beverage container needs line cleaning in regular intervals to ensure that no micro organisms or soil deposit in lines and fittings. In order to carry out such line cleaning in a semi-automatic fashion a cleaning system is attached to and integrated into the local beverage dispensing system. A semi-automatic system in preferable over a fully-automatic system (e. g. WO 01/94040 A1) mainly from a cost-related assessment.

The system for semi-automatic line cleaning in a beverage dispensing system which forms the starting point of the invention (EP 0 269 152 B1) has a control unit installed normally downstairs next to the kegs or beverage containers. The control unit has a control panel with a selection knob that can be set to a rest position and to as many positions as beverage containers are available in the beverage dispensing system. Next to the selection knob on the control panel are two switches for a gas valve and a water valve being part of the line cleaning system. When the beverage dispensing system shall be cleaned the selector knob is set to the rest position thus disconnecting the heads on the beverage containers and connecting washing adapters. When the switches for gas and water are pressed the gas and water starts to expel remaining beverage from the beverage lines and starts to wash out all the beverage lines in a selected pattern. Such pattern may include a pre-flush, chemical dosing, intermediate rinsing, additional chemical dosing and final rinsing for the necessary time intervals.

The prior art system suffers from the drawback that even if the system operates in a semi-automatic fashion and the positioning of the control unit next to the beverage containers in the basement of a building is convenient as far as handling of the beverage containers is concerned, it is not so convenient with regard to an effective cleaning of the lines up to the tap or taps which are normally at the bar upstairs. Usually two persons are necessary to work with this line cleaning system.

Further, the prior art line cleaning system is open to maloperation, because it can be switched into the tapping mode without any safety features.

Finally, the prior art system is only as effective as the person using this system is, because it solely relies on the operator with regard to cleaning intervals etc.

The present invention now has as an object to improve the prior art line cleaning system for beverage line cleaning.

The solution for above defined problem is found in a system with the features of the preamble of claim 1 additionally provided with the features of the characterizing part of claim 1.

The prior art switching means is replaced by a key switch which allows access to the control unit and the switching means only for authorized personnel. Maloperation of the system for line cleaning is highly unlikely because only authorized and assumably well trained personnel will be in a position to change from tapping mode to cleaning mode.

Preferred improvements and modifications of this teaching may be obtained from claims 2 to 5. In particularly effective construction the system according to this invention is characterized in that the switching means is provided with a socket with a detachable electro-mechanical key, wherein the key element of this key is a permanent magnet and the switching element assigned to the socket is a magneto-reactive element, mostly a Hall-sensor.

In the preferred embodiment the key element is not a mechanical key or a electronic key in the traditional sense, but it is a specific identification means easily recognizable as being relevant for the beverage dispensing system.

In an independent aspect of the invention the system is characterized by the features of claim 6. The switching means here is additionally provided with an optical status indicator. An optical status indicator is an additional safety means, because it allows for clear indication of the status of the system. This will be explained in detail later in connection with the description of a preferred embodiment of the invention.

In particular an optical status indicator allows for an additional feature, namely an alerting mode of the optical status indicator indicating that cleaning of the beverage line system is due or overdue. Such cleaning interval may be programmed into the control unit by an operator, but may be alternatively or additionally calculated by the control unit following the specific load handled by the beverage dispensing system.

Finally, there is a further independent teaching of the present invention that is important for an overall attractive beverage line cleaning system. This further teaching is related to the fact that, irrespective of the location of the control unit, the switching means may be positioned next to the beverage tap. This needs only one connecting line between switching means and control unit. Even this may be realized in a wireless way so that the beverage dispensing system needs no modification in this respect. The switching means may be positioned next to the beverage tap on the panel.

Now, other and further advantages and features of the invention will be apparent to a person skilled in the art from the following detailed description of the invention taken in conjunction with the accompanying drawings. In the drawings

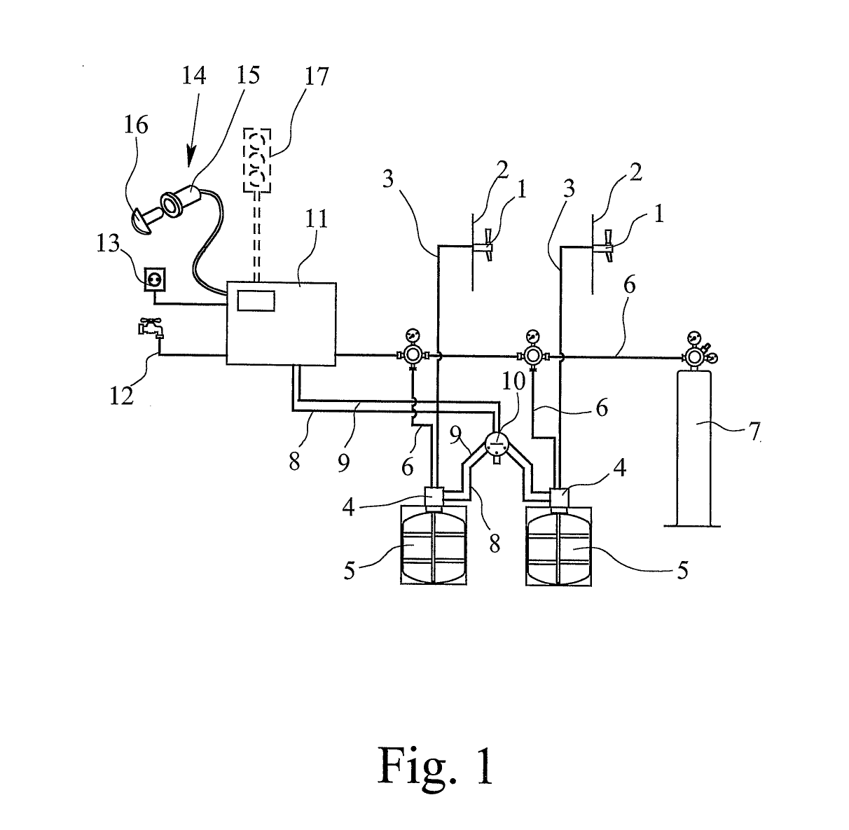

FIG. 1 is a schematic display of a beverage dispensing system including a line cleaning system according to the invention,

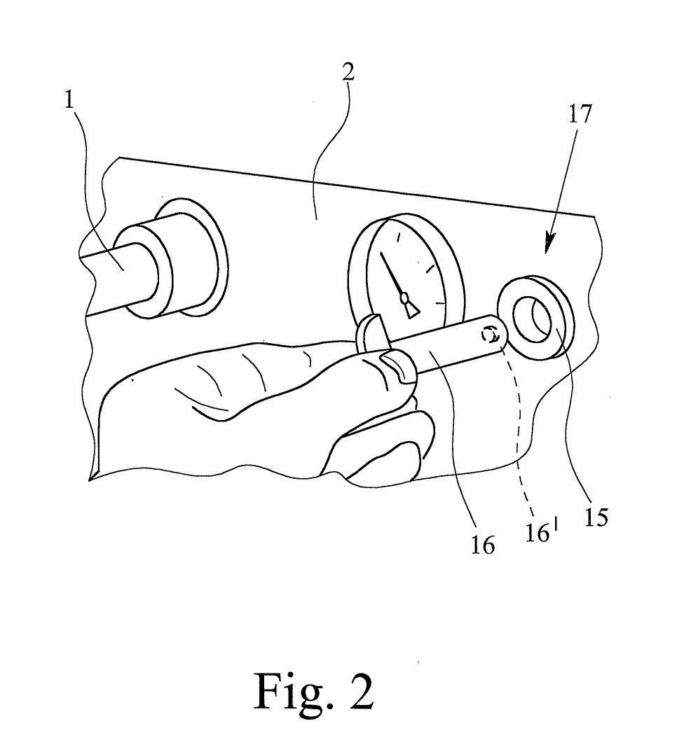

FIG. 2 is a schematic view of a tap panel with a tap and a switching means next to it,

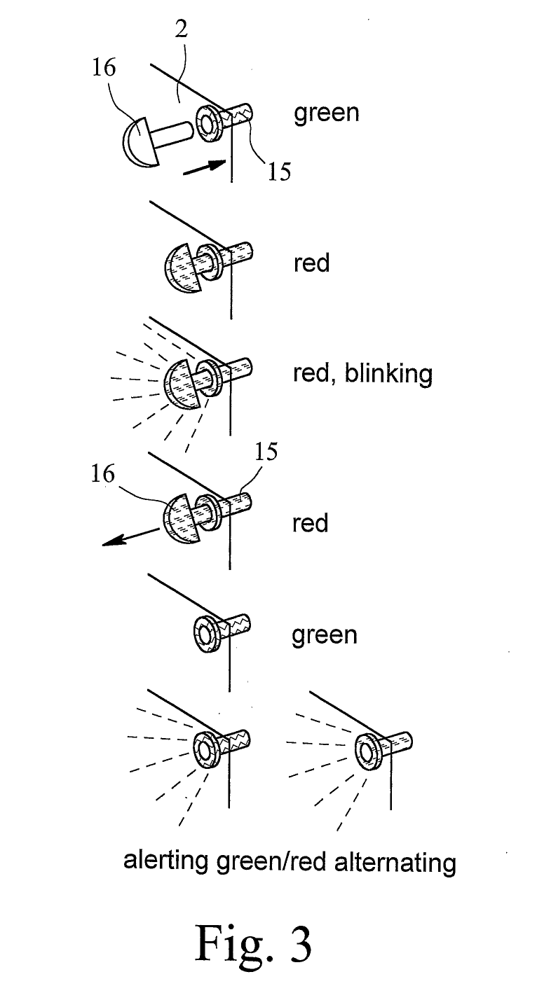

FIG. 3 is a schematic listing of all indication alternatives of a preferred switching means and optical status indicator.

FIG. 1 gives an overview of the installation of a beverage dispensing system. This system comprises two taps 1, probably next to each other at the same tap panel 2. Each tap 1 is connected via a beverage line 3 to a coupling means 4 on a beverage container 5. This beverage container 5 can be a keg, as indicated, in particular in a beer dispensing system a beer keg. However, other beverage containers 5 may be used as well.

The coupling means 4 on the beverage containers 5 are connected by pressure lines 6 to a pressure source 7, here a CO₂-bottle with a pressure reduction system on top.

The cleaning system comprises additional cleaning lines 8 and pressure lines 9, a water/gas-manifold 10 to distribute the specific fluid to the different locations, a control unit 11 connected to a water tap 12, and power supply 13, and at least one switching means 14 connected to the control unit 11.

The switching means 14 is provided for switching the beverage dispensing system including the line cleaning system according to the invention between a tapping mode and a cleaning mode.

As can be seen in FIG. 1 and FIG. 2 according to the invention the switching means 14 is not a simple change over switch, but is designed as an electronic key switch or a mechanical key switch. This provides for a higher level of safety of the semi-automatic line cleaning system.

If an electronic key switch shall be used it may be provided as a key-pad or as a contact card reader or contactless card reader or as a transponder as used in engine ignition lock means or closure systems. This can be combined with a mechanical lock in a traditional sense.

In the present embodiment, however, an electro-mechanical key switch is provided as switching means 14. As can be seen in FIG. 1 and FIG. 2 alike this switching means 14 has a socket 15 and a detachable electro-mechanical key 16 assigned thereto. In the present and preferred embodiment the key element of the key 16 is a permanent magnet 16′ and the switching element assigned to the socket 15 is a magneto-reactive element, which normally will be a Hall-sensor or the like.

FIG. 2 shows how the key 16 is inserted into the socket 15 on the tap panel 2 to initiate the cleaning cycle.

FIG. 2 in connection with FIG. 3 is related to a further safety feature of the invention. Whereas the features described above guarantee that cleaning is separated from tapping and unauthorized use is prevented, the further idea is that the switching means 14 is additionally provided with an optical status indicator 17. An optical status indicator 17, as indicated in dotted lines in FIG. 2, may be separate from the switching means 14. This, however, needs additional installation, wiring etc. Optical indication can be realized either by indicator lamps or by a display means with readings in plain text and/or symbols, colours etc.

Here, however, in this preferred embodiment, the inventive concept further realizes the fact that the optical status indicator 17 is integral part of the socket 15 of the switching means 14. No additional wiring is necessary.

As can be obtained from FIG. 3 in detail here the optical status indicator 17 is provided by lamps lighting up in different colours and/or in different intervals.

In the present invention the integration of switching means 14 and optical status indicator 17 is particularly effective, because here the optical status indicator 17 is provided by a transparent socket 15 illuminated from behind by lamps attached to the socket 15 with light of different colour and/or in different intervals. This integration is particularly effective and provides for a unique safety feature of the cleaning system.

The optical status indicator 17 forms the basis for a further improvement, namely an automatic or semi-automatic cleaning interval reminder system. Insofar the preferred embodiment of the invention is characterized in that the control unit 11 provides for a cleaning interval setting and/or calculation and the optical status indicator 17 is operable by the control unit 11 in an alerting mode indicating that cleaning of the beverage line system is due or overdue. In a preferred version of the invention it is provided that the alerting mode is indicated by blinking of the optical status indicator 17 alternatingly in red and green.

Altogether FIG. 3 shows the lighting of the socket 15 of the switching means 14 in constant green indicating the regular tapping mode. As soon as the key 16 is inserted into the socket 15 the light will switch from green to constant red. Opening of all taps 1 will give the signal to the control unit 11 to start the cleaning process. The red light will start to blink. Red blinking of socket 15 will continue during the cleaning operation. As soon as the cleaning operation is finished lighting of the socket 15 will switch from red blinking light to constant red. Now the key 16 may be removed from the socket 15 to again switch back to the tapping mode.

In a further preferred embodiment of the invention it is possible to provide for a safety locking of the switching means 14. Safety locking of the switching means 14 means that the key 16 cannot be removed from the socket 15 before the end of the cleaning program has been reached. Thus it is safely prevented that return to the tapping mode is prematurely enforced.

A further interesting system feature could be the introduction of a preliminary interval which is present directly after insertion of the key 16. This specific feature means that after insertion of the key 16 or other activation of the switching means 14, e. g. by means of a transponder or the like, there is provided this preliminary interval where removal of the key 16 or deactivation of the switching means 14 will prevent a start of the cleaning cycle. Instead a simple rinsing with water will take place for realizing an intermediate cleaning of the lines in the system without chemistry.

Programming of the control unit 11 with the time interval for this preliminary interval can activate or deactivate this preliminary interval. If the time for this preliminary interval is set to 0 s this additional step is not provided for. However, if the time interval is set to e. g. 5 s we have this preliminary interval in advance of a complete cleaning cycle.

As far as the optical status indicator 17 is concerned, in the preferred embodiment it would be particularly feasible to switch from green or green/red alternating to green blinking for the preliminary interval after insertion of the key 16.

As can be seen from FIG. 2 in a very preferred embodiment of the invention it is provided that irrespective of the location of the control unit, the switching means 14 is positioned next to the beverage tap 1. This convenient location of the switching means 14 is of particular importance in connection with the optical status indicator 17. The connection of the switching means 14 with the control unit 11 may be by cable or, even more convenient, by wireless connection.

1. System for semi-automatic line cleaning in a beverage dispensing system, said beverage dispensing system comprising at least one tap connected via at least one beverage line to at least one coupling means for a keg or other beverage container, said cleaning system comprising at least one additional cleaning line, a control unit and at least one switching means connected to the control unit for switching between a tapping mode and a cleaning mode of the beverage dispensing system, wherein the switching means is designed as an electronic or a mechanical key switch.

2. System according to claim 1, wherein the switching means in the form of an electronic key switch is selected from the group consisting of a key pad, contact card reader, contactless card reader, and a transponder.

3. System according to claim 1, wherein the switching means as a mechanical key switch is provided as a socket with a detachable mechanical or electro-mechanical key.

4. System according to claim 3, wherein the key element of an electro-mechanical key is a permanent magnet and the switching element assigned to the socket is a Hall-sensor.

5. System according to claim 1, wherein the switching means in connection with the control unit is provided with a safety feature preventing removal of the key from the socket before the end of the cleaning sequence.

6. System according to claim 1, wherein the switching means further comprises an optical status indicator.

7. System according to claim 6, wherein the optical status indicator is provided by a lamp or lamps lighting up in different colours or in different intervals.

8. System according to claim 7, wherein the optical status indicator is provided by a transparent socket illuminated from behind by a lamp or lamps with light of different colour or in different intervals, wherein the lamp or lamps are attached to or part of the socket.

9. System according to claim 6 wherein the control unit provides for a cleaning interval setting or calculation and the optical status indicator is operable by the control unit in an alerting mode indicating that cleaning of the beverage line system is due or overdue.

10. System according to claim 9, wherein the alerting mode is indicated by blinking of the optical status indicator alternatingly in red and green.

11. System according to claim 1, wherein after insertion of the key or other activation of the switching means there is provided a preliminary interval where removal of the key or deactivation of the switching means will start a rinsing step with water.

12. System according claim 1, wherein, the switching means is positioned next to the beverage tap.

13. System according to claim 6, wherein the optical status indicator is a display means with readings in text or symbols.
